(19) United States
(12) Patent Application Publication
(10) Pub. No.: US 2020/0156530 A1
(43) Pub. Date: May 21, 2020

(54) Control unit for controlling matrix headlights

(71) Applicant: Hella GmbH & Co. KGaA, Lippstadt (DE)

(72) Inventors: Boris Kubitza, Möhnesee-Körbecke (DE); Carsten Wilks, Lippstadt (DE)

(21) Appl. No.: 16/688,033

(22) Filed: Nov. 19, 2019

(30) Foreign Application Priority Data
Nov. 21, 2018 (DE) 102018129280.5

(51) Int. Cl. B60Q 1/14; G06K 9/00

(52) U.S. Cl. CPC B60Q 1/1415; H04N 5/2354; G06K 9/00818; G06K 9/00798

(57) ABSTRACT

A control unit is provided for controlling matrix headlamps, especially in vehicles, with at least one interface for at least one of: reading in initial information about objects that are recorded by means of an image recognition system, for example other road users, and for transmitting control signals to at least one matrix headlamp that is suitable for illuminating a traffic situation. The type of light distribution is to be generated by the matrix headlamps to illuminate the traffic situation may be determined with the control unit, or it can be read into the control unit at an interface. The control unit can be used to define at least one initial area in the traffic situation that can be illuminated by the matrix headlamps depending on initial information, in that a brightness that deviates from the selected light distribution is set. The control unit can be used to define at least one second area in the traffic situation which can be illuminated by the matrix headlamps with a brightness that deviates from the selected light distribution irrespective of the initial information.

### CROSS REFERENCE

This application claims priority to German Patent Application 10 2018 129280.5, filed Nov. 21, 2018, the entirety of which is hereby incorporated by reference.

### FIELD OF THE INVENTION

A Control unit (S) for controlling at least one matrix headlamp, in particular in vehicles, wherein: it is possible to determine with the control unit (S) or to read into the control unit at an interface what type of light distribution is to be generated by the matrix headlamp in order to illuminate the traffic situation; at least one control signal for at least one matrix headlamp can be set with the control unit (S) in order to set the light distribution; and the control unit (S) has at least one interface (11) for providing the control signal.

### BACKGROUND

Control units can be used to control matrix headlamps, especially LED matrix headlamps, to illuminate a traffic situation. For this purpose, a control signal can generate control signals. These control signals are used by the matrix headlamp or matrix headlamps connected to the control unit in order to generate signals that are used to control the individual elements of the matrix, such as the individual LEDs, so that they emit a desired amount of light. A control signal is transmitted from the control unit to the matrix headlamp or matrix headlamps, with which the control unit provides the matrix headlamps with electrical values that are to be set with the matrix headlamps in order to set the desired light distribution. This can, for example, be a high beam distribution or a low beam distribution. Other light distributions can also be set. The matrix headlamp is now able to generate this light distribution based on the electrical values transmitted to it.

The electrical values specified by the control unit for setting the matrix headlamps are individual for each type of headlamp and each vehicle. In order for the control unit to be able to be used for different types of headlamps and vehicles, it must generate suitable electrical values for the headlamps. The possibility of using the control unit for different types of headlamps and vehicles makes it necessary to adapt the control unit to different types of headlamps and vehicles. This can entail extensive programming and parameterization work.

Further, controlling headlamps so as to avoid glare for other road users, in particular drivers in oncoming vehicles or vehicles up ahead, is known. For this purpose, cut-off lines are shifted so that, in the illuminated traffic situation, initial areas arise in which the brightness is reduced compared with the light distribution that is usually to be set at this point based on the selected light distribution. These initial areas with reduced brightness are also sometimes referred to as tunnels in which the glare-free vehicle moves.

Whereas in conventional headlamps with one light source, the initial areas are created by screens that are pushed or swiveled in front of the light source, or by swiveling the headlamp, with matrix headlamps it is possible to create the initial areas without using mechanical aids. In contrast to conventional headlamps, this makes it easy to reduce the brightness in several initial areas at the same time by selectively switching matrix elements on or off or dimming them. This makes it easier to remove glare from several road users in different places at the same time.

It has been shown that, beyond removing glare for other road users, it can be useful to change the illumination by setting the light distribution.

Irrespective of the reason why individual areas of the illuminated traffic situation are more or less illuminated with a set light distribution, the control unit takes these areas into account when generating the electrical values. In matrix headlamps, these areas are controlled, for example, by the control unit by means of the electrical values in such a way that the brightness in this area is higher or lower than otherwise specified by the light distribution. The control unit must be set up for this purpose.

### SUMMARY OF THE INVENTION

The present invention is based on the problem of further developing a control unit for a matrix headlamp in such a way that a more universal use of the control unit is also possible.

This problem is solved by the invention, in that the control unit can be used to define on request at least one area in the traffic situation that can be illuminated by the matrix headlamps in which a brightness that deviates from the selected light distribution is to be set, and in that the area and the deviating brightness are defined in the control signal.

In contrast to control units known from the state of the art, the control unit according to the invention does not generate any concrete electrical correcting variables or control variables that act on the actuators of the headlamp and thus lead to the setting of the headlamp. The control unit according to the invention informs the headlamp of the light distribution to be set. In addition, areas of the traffic situation that is to be illuminated in which a brightness deviating from the light distribution is to be set are defined in the control signals that are transmitted from the control unit to the headlamp in a way that can be understood by the headlamp, for example through a description language. The control unit communicates to the headlamps what the headlamps are to achieve by illuminating the traffic situation. In the headlamp, the correcting variables with which the actuators of the headlamp are controlled are then generated in order to control the headlamps so that this result can be achieved.

Geometric variables such as angle specifications, coordinates, lengths and/or similar, or photometric variables, such as absolute illuminance, an illuminance difference from the illuminance provided by the light distribution or similar, can be used to define the area and the deviating brightness in this area.

Via the interface of a control unit according to the invention, initial information about objects detected by means of an image acquisition system, for example other road users, can be read into the control unit. Depending on the initial information, the control unit can then be used to define at least one initial area in the traffic situation which can be illuminated by the matrix headlamps, in which the brightness deviating from the selected light distribution can be set.

Using the control unit, at least one second area in the traffic situation that can be illuminated by the matrix headlamps with a brightness deviating from the selected light distribution can be defined independently of the initial information. In this second area, the brightness could be reduced or increased, especially when compared with the brightness set or to be set for this area based on the selected light distribution. A reduction can be useful, for example, to reduce or prevent glare caused by reflections of the light generated by the matrix headlamp. An increase can be useful, for example, to draw the driver's attention to certain points in the traffic situation. The second area, of which there is at least one, can be defined like the initial area, of which there is at least one, in terms of its position, extension and shape as well as in terms of its brightness.

At least one second piece of information can be read into the control unit via the interface, of which there is at least one, of a control unit according to the invention. Depending on this second piece of information, the second area, of which there is at least one, can be defined.

A control unit according to the invention can also be set up to assign priorities to the areas. This applies to both the initial areas and the second areas. This can serve to avoid conflicts, which will be explained later. Priorities can depend on the initial and/or second information based on which the areas are defined. The type of information and/or the content of the information can be taken into account for this purpose. For example, areas that are based on a certain type of information can be assigned a higher priority than other areas from the start, regardless of the content of the information. For example, an initial area used to remove glare for another road user may be granted a higher priority than a second area which is set up, for example, based on a second piece of information concerning an object on the side of a road for which increased illumination is useful.

The second piece of information, of which there is at least one, can be information from a blind spot sensor, about a vehicle driving beside the vehicle, about road signs, about a road type, about a change between two light distributions, about a course of the road, in particular about bends, and/or another piece of information that makes a deviation from the illumination by the set light distribution desirable or useful.

Information from a blind spot sensor that signals that a vehicle is to the right or left of the vehicle in question can, for example, be used to provide a second area to the right or left edge of the illuminated traffic situation. The vehicle that may be overtaking the vehicle in question can then be glare-free before it is captured by an image capture system that records the traffic situation in front of the vehicle.

Information about a road sign can also be used to place a second area around the road sign to reduce the illumination in this second area in order to avoid glare from the light reflected from the road sign.

Information about the course of the road, in particular about a bend, can be taken into account, for example, by creating, in the direction of the road, a second area which is more strongly illuminated. The information can, for example, be provided by a navigation system and/or the image acquisition system.

Information about an impending change between two light distributions can, for example, be used to create a second area in which the illumination is increased or decreased in order to avoid an abrupt change in brightness. One could, for example, ensure that when switching from a high beam to a low beam, two second areas with reduced brightness are created which constantly increase from the outside to the inside and which together have the appearance of a curtain closing. Conversely, when switching from a high beam to a low beam, it would be possible to create two second areas of increased brightness, widening from the inside, with the appearance of a curtain opening.

Information about a road type can be used, for example, to reduce the illumination in second areas during high beam distribution. For example, if the high beam distribution is set, glare from oncoming vehicles, which may be detected inadequately by an image acquisition system due to a central strip, can be avoided on a motorway. A second area can also be created at the left edge of the illuminated traffic situation.

By means of a control unit according to the invention, adjacent areas or overlapping areas, for which a brightness deviation from the selected light distribution in the same direction is set, can be combined to form an area. If the areas have a different priority, the brightness value and the priority of the area that previously had the higher priority can be determined for the resulting area.

By means of a control unit according to the invention, the area with the lower priority can be reduced by the overlapping area for overlapping areas for which a brightness deviation from the selected light distribution is set in different directions.

In a control unit according to the invention, it is possible to define a quantity of areas for which control signals can be generated with the control unit, which can be transmitted via the interface to the matrix headlamp or matrix headlamps. This quantity of areas for which the control unit generates control signals can be less than the quantity of areas defined by the control unit. This can be useful if the matrix headlamp or matrix headlamps can only process control signals for a limited quantity of areas. If, for example, a matrix headlamp can process control signals for three areas, it is useful to set up the control unit such that control signals are only generated for three areas.

In the event that the defined quantity of areas for which control signals can be generated by the control unit is less than the quantity of defined areas, the control unit can be used to select from all specified areas areas for which the control unit generates control signals for the matrix headlamp or matrix headlamps, whether initial or second areas. By means of the matrix headlamps, these control signals can then be used to illuminate the traffic situation in the selected areas with a brightness deviating from the selected light distribution.

The control unit is preferably set up in such a way that the areas with the higher priority are preferred when selecting areas from the defined areas.

In the event that the defined quantity of areas for which control signals can be generated with the control unit is equal to or greater than the quantity of defined areas, all defined areas can be selected by means of the control unit. The control unit can then be used to generate control signals for the matrix headlamp or matrix headlamps for all defined areas in order to illuminate the traffic situation in these areas with the matrix headlamp or matrix headlamps with a brightness that deviates from the selected light distribution.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 is a traffic situation with an illumination with a specified light distribution and areas with a brightness that deviates from the light distribution.

FIG. 2 is an illustration of the determination of the areas with a brightness that deviates from the light distribution.

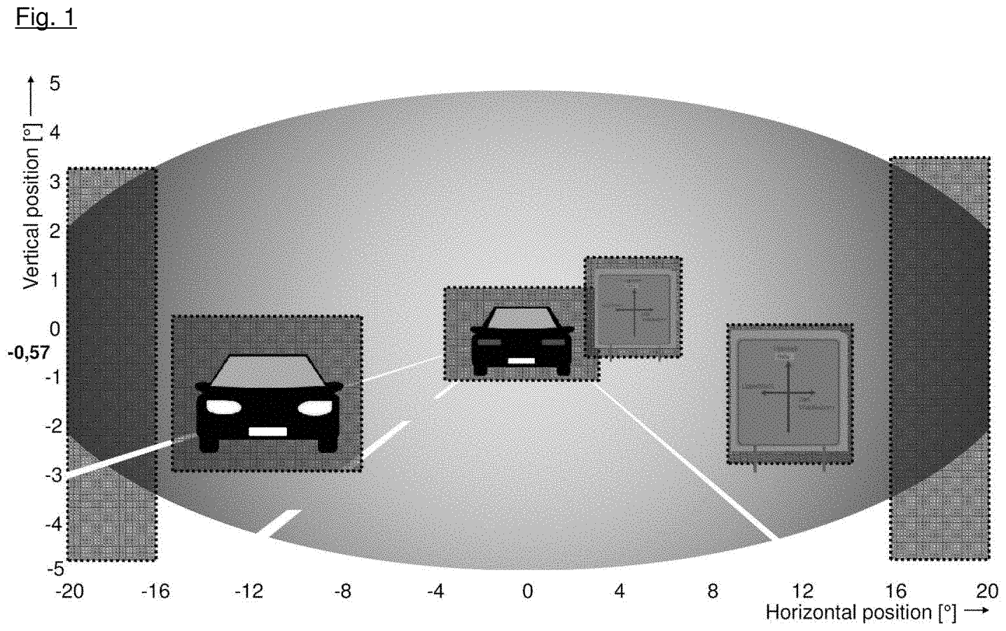

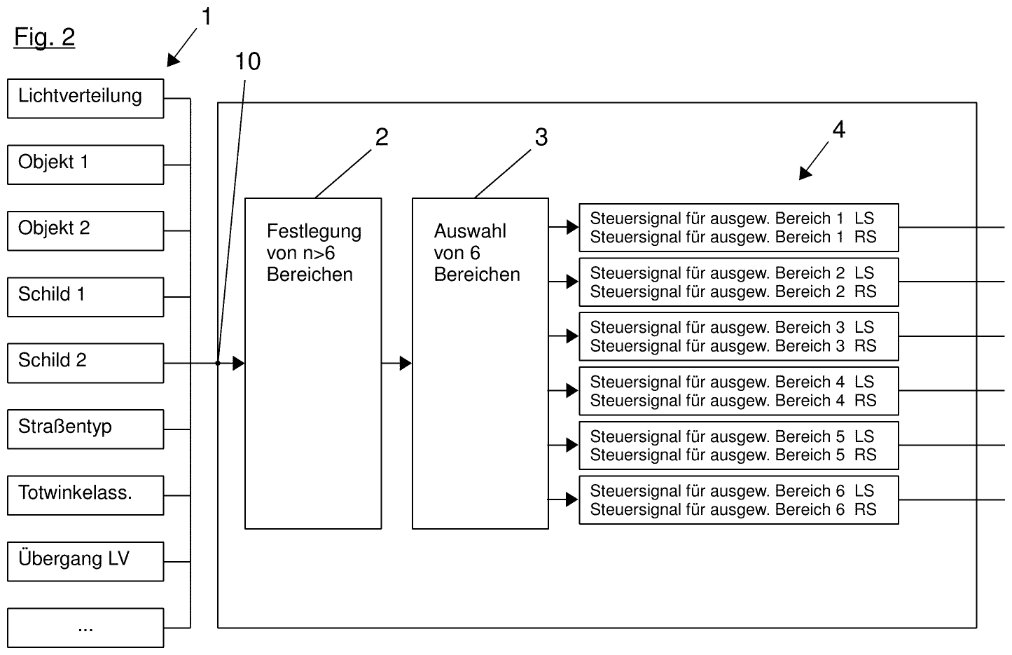

The traffic situation depicted in FIG. 1 shows a two-lane road with a preceding and an oncoming vehicle and two road signs. The situation is illuminated with light distribution. The oncoming vehicle and the vehicle in front should be glare-free. For this purpose, initial areas in which both vehicles are located are defined. Road signs are to be illuminated with a lower brightness to avoid reflections with glare. Second areas are defined for the road signs in which the brightness is reduced compared to the set light distribution. In addition, two second areas are defined on the right and left edges of the illuminated traffic situation in which the brightness is also reduced.

The areas with the brightness that has been changed compared with the set light distribution can be determined using a control unit according to the invention. Control signals, which are supplied to the matrix headlamps of the vehicle in question, can also be generated by means of the control unit according to the invention. The control signals indicate the light distribution to be set and the areas in which a brightness that deviates from the light distribution is to be set.

The control unit S can define the light distribution depending on information that is read into control unit S. The control unit S can be set up to define areas depending on the initial and second information 1. The information 1 about the light distribution and the initial and second information can be read into control unit S via an interface 10. For every initial and second information 1, the control unit can define an area which is to be illuminated with a brightness that deviates from the light distribution (Ref no. 2).

The matrix headlamps are set up in such a way that they can be used to illuminate six areas each with a brightness that deviates from the light distribution. However, as the control unit defines more than six areas, it is necessary to select six from the defined areas (Ref no. 3). This is done on the basis of priorities assigned to an area depending on the type of information 1 and/or the content of information 1 that was used as the basis for defining the area.

The six areas with the highest priority are then taken into account during the selection. A high priority is given to the areas that have been defined in order to reduce glare to other road users. The next lower priority is given to areas that concern road signs and remove glare for the driver of the vehicle in question.

For the selected areas, the control unit S according to the invention then generates control signals (Ref no. 4) with which the matrix headlamps are controlled in order for the traffic situation to be illuminated as desired.

### LIST OF REFERENCE SYMBOLS

S Control unit
1 Information
2 Definition of areas
3 Selection of areas
4 Generation of control signals
11 Interface

We claim:

1. A control unit for controlling at least one matrix headlamp, in particular in vehicles, the control unit performing the following steps:
at least one of: determining a type of light distribution is to be generated by the matrix headlamp in order to illuminate the traffic situation, and accepting an input of the type of light distribution that is to be generated by the matrix headlamp in order to illuminate the traffic situation;
setting at least one control signal for at least one matrix headlamp in order to set the light distribution;
providing the control signal via at least one interface of the control unit;
defining, upon request, at least one area in the traffic situation that can be illuminated by the matrix headlamps in which a brightness that deviates from the selected light distribution is to be set; and
wherein the at least one area and the deviating brightness are defined in the control signal.

2. The control unit according to claim 1, wherein the at least one area is defined in the control signal by at least one of angle specifications, coordinates, lengths, and other geometric variables.

3. The control unit according to claim 1, wherein the brightness in the control signal is defined as a photometric variable.

4. The control unit according to claim 1, wherein initial information about objects that are detected by means of an image acquisition system are read in via the interface, and wherein the control unit defines, depending on the initial information, at least one initial area in the traffic situation which can be illuminated by the matrix headlamps, in which the brightness that deviates from the selected light distribution can be set.

5. The control unit according to claim 4, wherein the control unit can be used to define, independently of the initial information, at least one second area in the traffic situation, which can be illuminated by the matrix headlamps with a brightness that deviates from the selected light distribution.

6. The control unit according to claim 1, wherein a second piece of information, of which there is at least one, can be read in via at least one interface, based on which a second area, of which there is at least one, is defined.

7. The control unit according to claim 1, wherein the control unit is set up to assign priorities to the areas, in particular depending on the initial and/or second information, which forms the basis for defining the areas.

8. The control unit according to claim 6, wherein the second piece of information is at least one of: information from a blind spot sensor about a vehicle driving beside the vehicle, about road signs, about a road type, about a change between two light distributions, about a course of the road, and another piece of information.

9. The control unit according to claim 1, wherein areas that are adjacent to another or overlapping one another, for which a brightness deviation from the selected light distribution is set in the same direction, are combined into one area.

10. The control unit according to claim 3, wherein, for areas overlapping one another, for which a brightness deviation from the selected light distribution is set in a different direction, the area with the lower priority is reduced by the overlapping area.

11. The control unit according to claim 1, wherein a quantity of areas is defined for which control signals are generated, which can be transmitted via the interface to the matrix headlamp or matrix headlamps.

12. The control unit according to claim 7, wherein, in the event that the defined quantity of areas for which control signals are generated is smaller than the quantity of defined areas, selecting from all the defined areas for which control signals can be generated for the matrix headlamp or matrix headlamps in order to illuminate the traffic situation in these selected areas by means of the matrix headlamps with a brightness which deviates from the selected light distribution.

13. The control unit according to claim 8, wherein when selecting the areas from the defined areas, the areas with the higher priority are preferred.

14. The control unit according to claim 7, wherein, in the event that the defined quantity of areas for which control signals are generated is the same as or greater than the quantity of defined areas, selecting from all the defined areas,
wherein control signals for the matrix headlamp or matrix headlamps are generated for these defined areas in order to illuminate the traffic situation in these selected areas by means of the matrix headlamps with a brightness that deviates from the selected light distribution.
